(19) United States
(12) Patent Application Publication
(10) Pub. No.: US 2026/0057862 A1
(43) Pub. Date: Feb. 26, 2026

(54) SETTING SYSTEM, SETTING METHOD, AND SETTING DEVICE

(71) Applicant: Roland Corporation, Shizuoka (JP)

(72) Inventors: Yoshinobu MORIMOTO, Hamamatsu (JP); Masato UENO, Hamamatsu (JP)

(73) Assignee: Roland Corporation, Shizuoka (JP)

(21) Appl. No.: 18/991,737

(22) Filed: Dec. 23, 2024

(30) Foreign Application Priority Data
Aug. 23, 2024 (JP) 2024-141803

(51) Int. Cl. G10H 1/00

(52) U.S. Cl. CPC G10H 1/0008; G10H 1/0033; G10H 1/0091; G10H 2220/106; G10H 2220/116

(57) ABSTRACT

A setting system includes an electronic instrument and a setting device. The electronic instrument includes a first processor that inputs performance information, adds effect processing to a musical sound based on the performance information, outputs the musical sound with the effect processing added, receives a setting instruction from the setting device in which an order of the effect processing or parameters of the effect processing are set, and updates the order of the effect processing or the parameters of the effect processing to be added to the musical sound based on the setting instruction.

### CROSS-REFERENCE TO RELATED APPLICATION

This application claims the priority benefits of Japanese application no. 2024-141803, filed on Aug. 23, 2024. The entirety of the above-mentioned patent application is hereby incorporated by reference herein and made a part of this specification.

### BACKGROUND

### Technical Field

The disclosure relates to a setting system, a setting method, and a setting device.

### Description of Related Art

Patent Literature 1 (International Publication No. WO 2019/143364) discloses a device 100 in which effect processing is added to a musical sound based on performance information from a connected electric guitar and the musical sound is output. A display device 1 of the device 100displays an icon 410 etc. imitating an effector (for example, a pedal type effector), and is configured so that a user can connect and arrange multiple icons 410 etc. Effect processing set according to the order of arrangement of multiple icons 410 etc. and the setting information of the effectors corresponding to the icons 410 etc. is added to the musical sound based on the input performance information and the musical sound is output.

In the case of applying the effect processing setting using such icons 410 etc. to a guitar amplifier that simulates the effect processing of an effector by a Digital Signal Processor (DSP), it is difficult to provide a large display device like the display device 1 in the guitar amplifier because the guitar amplifier has built-in components such as an amplifier for amplification, a power supply, a speaker for sound emission, and a heat sink for heat dissipation. Therefore, the applicant of the application adopted a configuration to perform effect processing settings using the icons 410 etc. similar to the icons in Patent Literature 1 on an application of a PC connected to the guitar amplifier.

However, in either case of using the device 100 or using an application on a PC, the same image icon is displayed for the same type of effector, such as the icon 410. Therefore, when disposing two or more effectors of the same type, even if the setting information is different, two or more icons with the same image are displayed. Thus, it is difficult for the user to distinguish which icon represents which effector with which setting.

The disclosure provides a setting system, a setting method, and a setting device that allow the user to easily distinguish displayed effectors.

### SUMMARY

The setting system of the disclosure includes an electronic instrument and a setting device. The electronic instrument includes a first processor that inputs performance information, adds effect processing to a musical sound based on the input performance information, outputs the musical sound with the effect processing added, receives a setting instruction from the setting device in which an order of the effect processing or parameters of the effect processing are set, and updates the order of the effect processing or the parameters of the effect processing to be added to the musical sound based on the setting instruction received. The setting device includes a second processor that displays an effector icon which shows a standard image imitating an effector that performs the effect processing, acquires an effector icon specified by the user from among the effector icons displayed, acquires a specified image specified by the user, displays the specified image acquired instead of the standard image in the effector icon acquired, acquires a connection order of the effector icons displayed set by the user, creates a setting instruction in which the order of the effect processing is set based on the connection order of the effector icons acquired, and transmits the setting instruction created to the electronic instrument.

The setting method of the disclosure causes a computer including a display section and connected an electronic instrument to create a setting instruction and transmit the setting instruction to the electronic instrument. The electronic instrument inputs performance information, adds effect processing to a musical sound based on the performance information input, outputs the musical sound with the effect processing added, receives a setting instruction in which an order of the effect processing or parameters of the effect processing are set, and updates the order of the effect processing or the parameters of the effect processing to be added to the musical sound based on the setting instruction received. The setting method is characterized by causing the computer to execute: a display step of displaying an effector icon which shows a standard image imitating an effector that performs the effect processing on the display section; a specified icon acquisition step of acquiring an effector icon specified by a user from among the effector icons displayed on the display section; a specified image acquisition step of acquiring a specified image specified by the user; an image change step of displaying the specified image acquired in the specified image acquisition step instead of the standard image in the effector icon acquired in the specified icon acquisition step; a connection order acquisition step of acquiring a connection order of the effector icons displayed on the display section as set by the user; a setting instruction creation step of creating a setting instruction in which an order of the effect processing is set based on the connection order of the effector icons acquired in the connection order acquisition step; and a transmission step of transmitting the setting instruction created in the setting instruction creation step to the electronic instrument.

The setting device of the disclosure is connected to an electronic instrument that inputs performance information, adds effect processing to a musical sound based on the performance information input, outputs the musical sound with the effect processing added, receives a setting instruction in which an order of the effect processing or parameters of the effect processing are set, and updates the order of the effect processing or the parameters of the effect processing to be added to the musical sound based on the setting instruction received. The setting device includes a processor that displays an effector icon which shows a standard image imitating an effector that performs the effect processing, acquires an effector icon specified by a user from among the effector icons displayed, acquires a specified image specified by the user, displays the specified image acquired instead of the standard image in the effector icon acquired; acquires a connection order of the effector icons displayed as set by the user; creates a setting instruction in which an order of the effect processing is set based on the connection order of the effector icons acquired, and transmits the setting instruction created to the electronic instrument.

### BRIEF DESCRIPTION OF THE DRAWINGS

FIG. 1 is a diagram representing an overview of the setting system.

FIG. 2A is a diagram representing the icon setting screen, and FIG. 2B is a diagram representing a case where a desired image of the user is specified in the icon setting screen.

FIG. 3A is a diagram representing the connection setting screen after changing the image of the icon, and FIG. 3B is a diagram representing the connection setting screen in the case where a laterally long image is specified in the icon setting screen.

FIG. 4 is a functional block diagram of the setting system.

FIG. 5A is a block diagram showing the electrical configuration of the PC and the guitar amplifier, and FIG. 5B is a schematic diagram showing the settings table.

FIG. 6 is a flowchart of the main processing.

FIG. 7 is a flowchart of the icon display processing.

### DESCRIPTION OF THE EMBODIMENTS

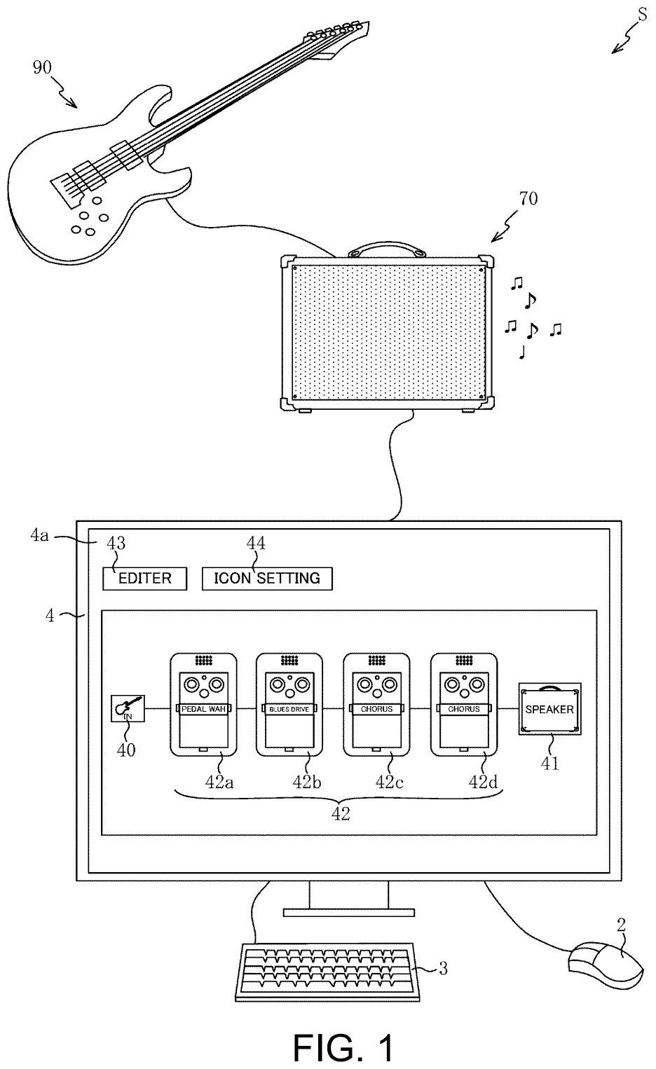

Hereinafter, exemplary embodiments are described with reference to the accompanying drawings. Referring to FIG. 1, an overview of a setting system S of the embodiment is described. FIG. 1 is a diagram representing an overview of the setting system S. The setting system S includes a PC 1 and a guitar amplifier 70. The PC 1 is a setting device (computer) for creating a setting for effect (acoustic effect) processing to be added to a musical sound output by the guitar amplifier 70, and for transmitting the setting to the connected guitar amplifier 70. The PC 1 is provided with a mouse 2 and a keyboard 3 for inputting an instruction from a user H, and an LCD 4 on which a connection setting screen 4a, to be described later, and other screens are displayed.

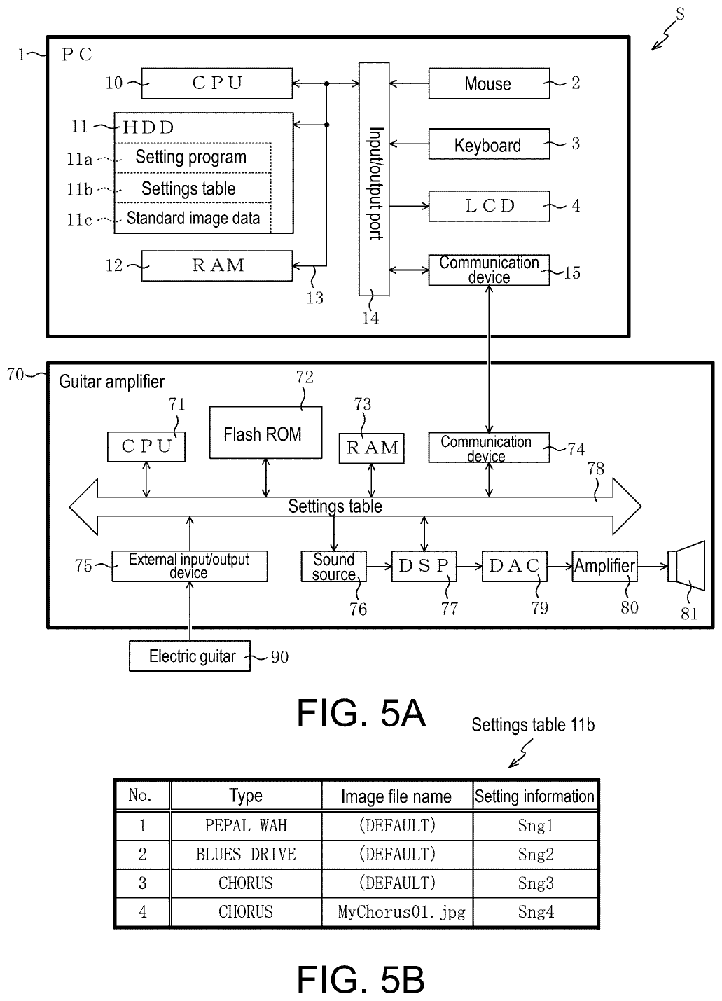

The guitar amplifier 70 is an electronic instrument that outputs a musical sound based on performance information input from a connected electric guitar 90. The guitar amplifier 70 has a built-in Digital Signal Processor (DSP) 77 (refer to FIG. 5A), which will be described later. In the DSP 77, effectors such as delay and reverb are simulated, and effect processing by the simulated effectors is added to the musical sound based on the performance information input from the electric guitar 90. In the embodiment, multiple effectors are simulated in the DSP 77, effect processing by the simulated effectors is sequentially added to the musical sound based on the input performance information and the musical sound is output.

In the PC 1, a setting instruction related to the effect processing to be added in the DSP 77 of the guitar amplifier 70 is created. Specifically, the setting instruction is data constructed from the connection order, which is the order in which multiple simulated effectors are connected, and the setting information of various parameters for each of the simulated effectors. The setting instruction for effect processing created in the PC 1 is transmitted to the guitar amplifier 70. In the guitar amplifier 70, effectors are simulated according to the connection order and setting information in the setting instruction received from the PC 1, and the effect processing is sequentially added to the musical sound based on the input performance information and the musical sound is output.

In the PC 1, the connection order of the effectors included in the setting instruction is set on the connection setting screen 4a displayed on the LCD 4. The connection setting screen 4a is a screen for setting the connection order of the effectors. The connection setting screen 4a displays an input part 40, an output part 41, icons 42a to 42d, a settings edit button 43, and an icon setting button 44.

The input part 40 is a display part that simulates an instrument (for example, an electric guitar) from which performance information is input. The output part 41 is a display part that simulates a speaker. It is indicated that a musical sound based on the performance information input from the input part 40 and subjected to effect processing by the effectors corresponding to the icons 42a to 42d, to be described later, is output from the output part 41.

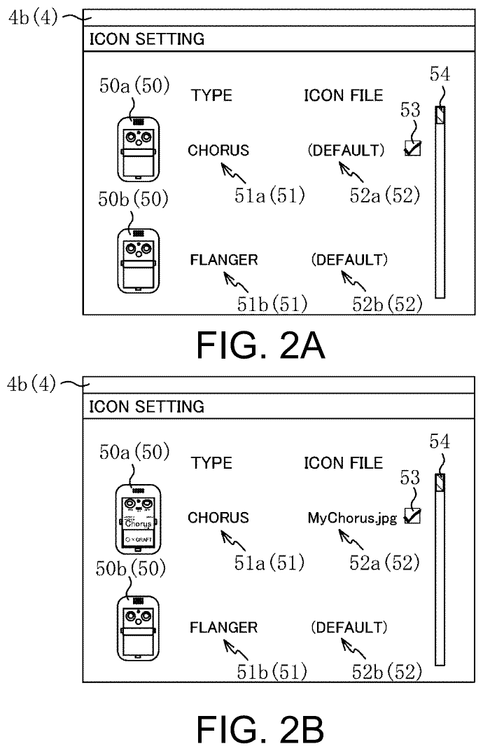

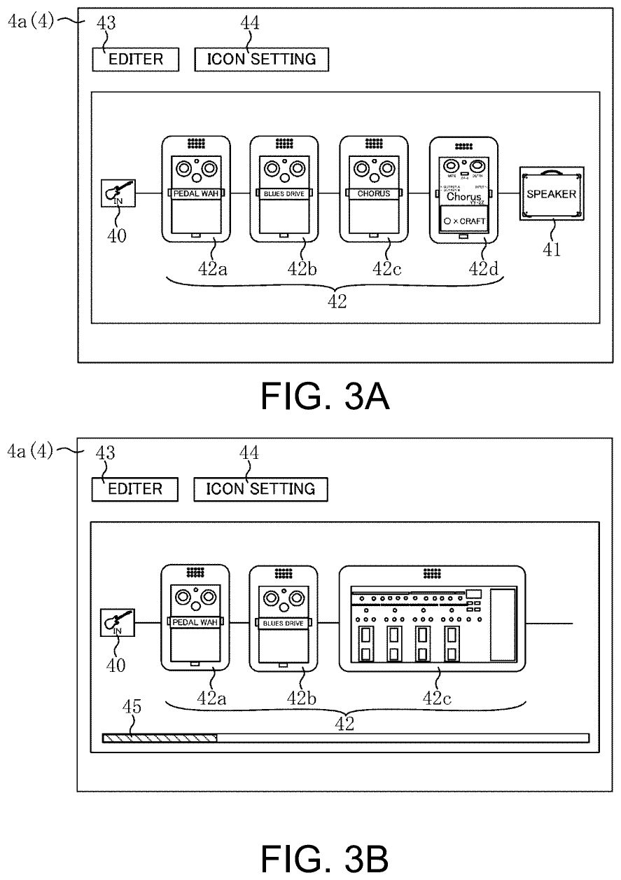

The icons 42a to 42d are display parts representing the respective simulated effectors. In FIG. 1, the icon 42a is assigned the “PEDAL WAH” effector, the icon 42b is assigned the “BLUES DRIVE” effector, and the icons 42c and 42d are each assigned the “CHORUS” effectors. Images simulating the respective effectors are displayed on the icons 42a to 42d. As will be described in detail later in FIGS. 2A and 2B and FIGS. 3A and 3B, the images of the respective icons 42a to 42d are configured to be changeable. Hereinafter, when not specifically distinguishing between the icon 42a to the icon 42d, the icons 42a to 42d will be referred to as an “icon 42”.

The icon 42a is displayed as connected to the input part 40, the icon 42b is displayed as connected to the icon 42a, the icon 42c is displayed as connected to the icon 42b, and the icon 42d is displayed as connected to the output part 41. This indicates that effect processing simulating the effector corresponding to the icon 42a is added to the musical sound based on the performance information input from the input part 40, and then effect processing simulating the effector corresponding to the icon 42b is added to the musical sound output from the effector corresponding to the icon 42a.

Furthermore, it is indicated that effect processing simulating the effector corresponding to the icon 42c is added to the musical sound output from the effector corresponding to icon the 42b, and then effect processing simulating the effector corresponding to the icon 42d is added to the musical sound output from the effector corresponding to the icon 42c, and that the resulting musical sound is then output from the output part 41.

In other words, the arrangement order of the icon 42a to the icon 42d represents the connection order of the effectors that add effect processing to the musical sound based on the input performance information, and the connection order is reflected in the setting instruction transmitted to the guitar amplifier 70. In the embodiment, the arrangement order of the icons 42a to the icon 42d is configured to be interchangeable by drag-and-drop operations using the mouse 2.

In the embodiment, the maximum number of the icons 42 that can be displayed on the connection setting screen 4a is set to four. In the case of displaying fewer than four icons 42 on the connection setting screen 4a, for example, when displaying three icons 42 on the connection setting screen 4a, the display of the icon 42d is omitted, and the icon 42c is displayed as connected to the output part 41.

It should be noted that FIG. 1 shows an example of displaying pedal type effectors on the icons 42, but the disclosure is not limited thereto. Other types of effectors besides the pedal type may be displayed on the icons 42. Additionally, the maximum number of the icons 42 that can be displayed on the connection setting screen 4a is not limited to four, and may be more than or less than four.

The settings edit button 43 is a button that changes the screen displayed on the LCD 4 from the connection setting screen 4a to a parameter setting screen (not shown). The parameter setting screen is a parameter screen for setting various parameters of the effectors assigned to the icons 42. After selecting any of the icons 42 with the mouse 2, selecting the settings edit button 43 with the mouse 2 displays a parameter setting screen for setting various parameters corresponding to the selected icon 42. The setting information of various parameters set by the parameter setting screen is reflected in the setting instruction transmitted to the guitar amplifier 70.

The icon setting button 44 is a button that changes the screen displayed on the LCD 4 from the connection setting screen 4a to the icon setting screen 4b for changing the image of the icon 42. After selecting any of the icons 42 with the mouse 2, selecting the icon setting button 44 with the mouse 2 displays the icon setting screen 4b for changing the image of the selected icon 42. The icon setting screen 4b will be described later in FIGS. 2A and 2B.

When an effector is assigned to the icon 42, a standard (default) image representing the corresponding effector, which is a standard image, is displayed as the image of the icon 42. In FIG. 1, since “CHORUS” effectors are assigned to the icons 42c and 42d respectively, the same standard image of “CHORUS” is displayed for each. When the user H repeatedly changes the settings of the effectors corresponding to the icons 42c and 42d on the parameter setting screen, it becomes difficult for the user H to distinguish which of the icons 42c and 42d represents the effector with which parameter settings.

In the embodiment, by changing the image of the icon 42 to an image desired by the user H using the icon setting screen 4b, the user H can easily distinguish the effectors assigned to the icons 42. Here, referring to FIGS. 2A and 2B, the icon setting screen 4b is described.

FIG. 2A is a diagram representing the icon setting screen 4b. The icon setting screen 4b displays preview icons 50a, 50b, . . . , types 51a, 51b, . . . , and icon files 52a, 52b, . . . for the respective types of effectors (delay, reverb, etc.).

As shown in FIG. 2A, the preview icon 50a, the type 51a, and the icon file 52a are displayed as corresponding to the “CHORUS” effector, the preview icon 50b, the type 51b, and the icon file 52b are displayed as corresponding to the “FLANGER” effector, and similarly, the preview icons 50a, 50b, . . . , the types 51a, 51b, . . . , and the icon files 52a, 52b, . . . corresponding to the types of effectors that can be set by the PC 1 are displayed.

The preview icons 50a, 50b, . . . display preview icons using images specified by the icon files 52a, 52b, . . . , which will be described later. The types 51a, 51b, . . . display the corresponding types of effectors.

The icon files 52a, 52b, . . . are display areas that specify the image file names, which are the file names of the images used for the icons. By selecting the icon files 52a, 52b, . . . with the mouse 2, an image file name input screen (not shown) is displayed, and the image of the image file name input on the image file name input screen is displayed in the icon files 52a, 52b, . . . In the case where an icon file such as the icon file 52a is “(DEFAULT)”, it indicates that a standard image for the type of effector is used as the image for the corresponding icon. Hereinafter, the image specified by the icon file 52a, etc. is referred to as the “specified image”.

FIG. 2B is a diagram representing a case where a desired image of the user H is specified in the icon setting screen 4b. In FIG. 2B, it shows a case where a specified image with the image file name “MyChorus. jpg” desired by the user H is specified in the icon file 52a as the image for the icon of the type of effector “CHORUS”. In the embodiment, the specified images designated in the icon files 52a, 52b, . . . use images stored in the PC 1, but images obtained from external networks such as the Internet may also be used.

In the case where “MyChorus. jpg” is specified in the icon file 52a, a preview icon using “MyChorus. jpg” as the icon image is displayed in the corresponding preview icon 50a. With the preview icon 50a, the user H can easily grasp what kind of icon is to be displayed based on the specified image designated in the icon file 52a.

A check display 53 is a display part for selecting which type of the effector icon to use for the icon 42 selected in the connection setting screen 4a displayed before changing to the icon setting screen 4b. By selecting the right side of the icon files 52a, 52b, . . . with the mouse 2, the check display 53 is shown on the right side of the icon files 52a, 52b, . . . , and the corresponding type of effector is used for the icon 42 selected in the connection setting screen 4a. In the example of FIG. 2A, in order to use the “CHORUS” icon for the icon 42 selected in the connection setting screen 4a, the check display 53 is shown on the right side of the icon file 52a.

A scroll display 54 is a display part for scrolling and switching the displayed preview icons 50a, 50b, . . . , the types 51a, 51b, . . . , and the icon files 52a, 52b, . . .

Here, the procedure for changing the image of the icon 42 in the connection setting screen 4a using the icon setting screen 4b is described. First, in the connection setting screen 4a of FIG. 1, the “CHORUS” icon 42c is selected, and the icon setting button 44 is selected with the mouse 2. This causes the icon setting screen 4b to be displayed. Next, by selecting the icon file 52a in the icon setting screen 4b with the mouse 2, an undepicted image file name input screen is displayed.

In the image file name input screen, the user H specifies the desired image “MyChorus. jpg”, and returns to the icon setting screen 4b. As a result, the preview icon 50a displays a preview icon using the specified image “MyChorus. jpg”.

After confirming the preview icon displayed in the preview icon 50a, the user H confirms that the check display 53 is shown to the right of the icon file 52a in order to apply the icon to the icon 42c in the connection setting screen 4a. If the check display 53 is not shown to the right of the icon file 52a, the user selects the right side of the icon file 52a with the mouse 2 to display the check display 53, and then returns to the connection setting screen 4a. Referring to FIG. 3A, the connection setting screen 4a displayed after changing the image of the icon 42 is described.

FIG. 3A is a diagram representing the connection setting screen 4a after changing the image of the icon 42. As shown in FIG. 3A, the specified image designated by the icon setting screen 4b is displayed on the icon 42c of the connection setting screen 4a. As a result, even for the same “CHORUS” effector, different images are displayed on the icon 42c (specified image) and the icon 42d (standard image), allowing the user H to easily distinguish between the icon 42c and the icon 42d.

As described above, the icons 42 imitating effectors are displayed and arranged in the lateral direction on the connection setting screen 4a, and the image of the displayed icon 42 is configured to be changeable to a specified image desired by the user H. As a result, in cases where two icons 42 of the same effector (“CHORUS”) are disposed on the connection setting screen 4a, such as the icon 42c and the icon 42d, the user H can easily distinguish the effectors by changing the images of the icons 42 to different images.

Incidentally, the specified image designated in the icon setting screen 4b does not need to be of a size that fits within the icon 42, and an image that is longer or shorter in the longitudinal direction or lateral direction than the icon 42 may be specified. In the embodiment, the image specified in the icon setting screen 4b is reduced or enlarged according to the prescribed size in the longitudinal direction of the icon 42 and then displayed on the icon 42. Here, referring to FIG. 3B, the reduction or enlargement of the image specified in the icon setting screen 4b is described.

FIG. 3B is a diagram representing the connection setting screen 4a in the case where a laterally long image is specified in the icon setting screen 4b. In FIG. 3B, the up-down direction is referred to as the longitudinal direction and the left-right direction is referred to as the lateral direction, and the same applies hereafter. In the embodiment, as the prescribed size of the image displayed on the icon 42, the prescribed size in the longitudinal direction is set to 300 pixels and the prescribed size in the lateral direction is set to 200 pixels, respectively. The standard images for the respective effectors mentioned above are all set to the prescribed size in both the longitudinal direction and the lateral direction.

The prescribed size is not limited to the above, and may be arbitrarily set, for example, according to the length in the longitudinal direction or the lateral direction of the connection setting screen 4a, or the maximum number of the icons 42 displayed on the connection setting screen 4a.

The icon 42c in FIG. 3B represents a case where an image with 1200 pixels in the longitudinal direction and 3000 pixels in the lateral direction is specified as the specified image in the icon setting screen 4b. If such a specified image is applied to the icon 42c as it is, the image may protrude from the icon 42c or the connection setting screen 4a, so the specified image is reduced.

First, the longitudinal direction of the specified image is reduced to the prescribed size of 300 pixels. The reduction rate at this time, that is, 300 pixels/1200 pixels =0.25, is calculated. Then, the lateral direction of the specified image is reduced based on the calculated reduction rate.

Specifically, since the length of the specified image in the lateral direction is 3000 pixels, the lateral direction of the specified image is reduced to 3000 pixels*0.25=750 pixels by multiplying the length by the calculated reduction rate of 0.25. The method for reducing or enlarging an image to a specified number of pixels uses a known technique, so a detailed description is omitted.

As a result, the specified image with 1200 pixels in the longitudinal direction and 3000 pixels in the lateral direction is reduced to 300 pixels in the longitudinal direction and 750 pixels in the lateral direction, and displayed in the icon 42c of the connection setting screen 4a, allowing the entire specified image to be displayed in the icon 42c. In addition, the length in the longitudinal direction of the image in the icon 42c becomes the same prescribed size as the length in the longitudinal direction of the images in other icons 42 where standard images are set, so the lengths in the longitudinal direction thereof are unified to the prescribed size.

Here, actual (physical) effectors have a structure in which the effect processing is turned on/off by a performer stepping on a pedal type switch provided on the casing. Therefore, in the case of arranging effectors in the longitudinal direction, when trying to turn on/off merely the switch of the effector disposed on the back side, the performer needs to stretch his/her foot further than the effector disposed on the front side. Moreover, the performer's foot may touch not only the switch of the effector disposed on the back side but also the switch of the effector disposed on the front side, making it difficult to switch on/off merely the effect processing of the effector disposed on the back side. Thus, it has become customary to arrange effectors in the lateral direction.

In the connection setting screen 4a of the embodiment, following the aforementioned custom, the icons 42 are arranged in the lateral direction. In the icons 42 arranged in the lateral direction, if the length in the longitudinal direction of the images thereof is unified, the user H is less likely to feel discomfort with the size of the icons 42. Therefore, by unifying the length in the longitudinal direction of the image in the icon 42c after image change to the prescribed size, such a way may reduce the user H's sense of discomfort regarding the size of the image between the icon 42c after image change and other icons 42, for example, the icons 42 with standard images set. In addition to this, such a way may give the user H a sense of uniformity in the size of the images of the icons 42.

Moreover, by setting the length in the longitudinal direction of the image in the icon 42c after image change to the prescribed size, the image may be suppressed from becoming too small, especially in the case of reducing the specified image. This can suppress the decrease in visibility of the icon 42c after image change.

Furthermore, the length in the lateral direction of the image in the icon 42c after image change is modified based on the reduction rate (magnification rate) when reducing (enlarging) in the longitudinal direction. As a result, the aspect ratio of the image in the icon 42c after image change becomes the same as the aspect ratio of the specified image, so the image in the icon 42c after image change may be suppressed from being distorted laterally or longitudinally compared to the specified image.

In the case where a laterally long image is specified as the specified image, the length in the lateral direction of the image in the icon 42c after image change becomes longer than the prescribed size of 200 pixels, thereby allowing the icon 42d and the output part 41 positioned to the right of the icon 42c to be displayed on the connection setting screen 4a. In this way, when the length in the lateral direction of the image in any of the icons 42a to 42d becomes longer than the prescribed size, and all of the input part 40, the icons 42a to 42d, and the output part 41 are unable to be displayed on the connection setting screen 4a at once, a scroll display 45 is displayed.

The scroll display 45 is a display part for scrolling and switching the displayed input part 40, icons 42a to 42d, and output part 41 on the connection setting screen 4a. By scrolling the scroll display 45, the input part 40, the icons 42a to 42d, and the output part 41 that can no longer be displayed at once on the connection setting screen 4a may be switched and displayed.

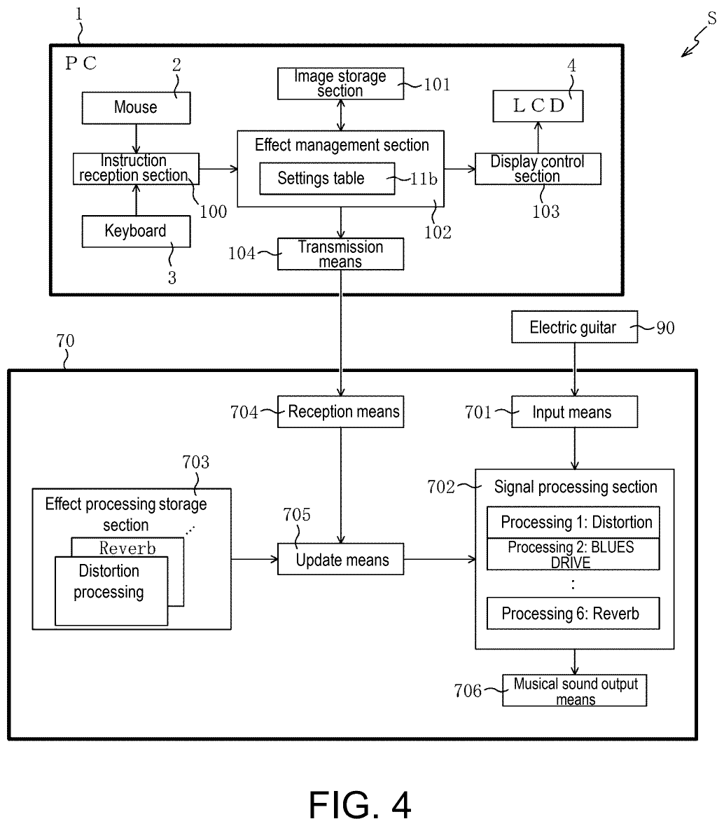

Next, referring to FIG. 4, the functions of the setting system S are described. FIG. 4 is a functional block diagram of the PC 1. As shown in FIG. 4, the PC 1 includes an instruction reception section 100, an image storage section 101, an effect management section 102, a display control section 103, and a transmission means 104. Additionally, the guitar amplifier 70 includes an input means 701, a signal processing section 702, an effect processing storage section 703, a reception means 704, an update means 705, and a musical sound output means 706.

First, the functions of the PC 1 are described. The instruction reception section 100 is a module that receives an instruction from the user H input via the mouse 2 and the keyboard 3, and is implemented by the CPU 10 to be described later in FIG. 5A. The image storage section 101 is a module in which standard images and specified images are stored, and is implemented by the HDD 11 to be described later in FIG. 5A.

The effect management section 102 is a module that manages the effectors assigned to the icons 42a to 42d, the order of the icons 42a to 42d, the images of the icons 42a to 42d, and the setting information of effectors assigned to the icons 42a to 42d, and is implemented by the CPU 10 and a settings table 11b to be described later in FIG. 5B.

In the effect management section 102, based on the user H's instruction received by the instruction reception section 100, the order of the icons 42a to 42d and the images of the icons 42a to 42d are changed, the creation of the connection setting screen 4a and the icon setting screen 4b using the images of the icons 42a to 42d obtained from the image storage section 101 is performed, and the creation of a setting instruction based on the order of the icons 42a to 42d and the setting information of various parameters of the effectors is carried out.

The display control section 103 is a module that transmits the connection setting screen 4a and the icon setting screen 4b created in the effect management section 102 to the LCD 4, and is implemented by the CPU 10. The transmission means 104 is a means for transmitting the setting instruction created in the effect management section 102 to the guitar amplifier 70, and is implemented by a communication device 15 to be described later in FIG. 5A.

In the PC 1, the icons 42 corresponding to effectors are displayed on the LCD 4 (connection setting screen 4a), and the setting instruction based on the connection order of effectors according to the order of the icons 42 and the setting information based on the parameters of the effectors is created and transmitted to the guitar amplifier 70. Here, while standard images are normally displayed for the icons 42, for the icons 42 specified by the user H among the displayed icons 42, specified images designated by the user H are displayed instead of the standard images. As a result, in the case where two or more icons 42 of the same type of effector are placed, by displaying a specified image instead of the standard image for one of the icons 42, the user H can easily distinguish the effectors.

Next, the functions of the guitar amplifier 70 are described. The input means 701 is a means for inputting performance information from the electric guitar 90, and is implemented by an external input/output device 75 to be described later in FIG. 5A. The signal processing section 702 is a module that adds effect processing to a musical sound based on the performance information input by the input means 701, and is implemented by the DSP 77. The effect processing storage section 703 is a module in which programs simulating various effectors are stored, and is implemented by the DSP 77.

The programs of effectors stored in the effect processing storage section 703 are loaded into the signal processing section 702, and in the signal processing section 702, corresponding effect processing is constructed by executing the loaded programs. The constructed effect processing is then added to the musical sound based on the performance information input by the input means 701.

The reception means 704 is a means for receiving a setting instruction from the PC 1, and is implemented by a communication device 74 to be described later in FIG. 5A. The update means 705 is a means for updating the order of the effect processing and the parameters of the effect processing to be added by the signal processing section 702 based on the setting instruction received by the reception means 704, and is implemented by a CPU 71 to be described later in FIG. 5A.

The update means 705 causes the signal processing section 702 to load the programs of effectors specified in the setting instruction received by the reception means 704, and then configures the signal processing section 702 to add the effect processing constructed by the loaded programs and the parameters of each of the effect processing specified in the setting instruction, in the connection order of the effectors specified in the setting instruction.

The musical sound output means 706 is a means for outputting a musical sound with effect processing added by the signal processing section 702, and is implemented by the DSP 77, and a sound source 76, a DAC 79, an amplifier 80, and a speaker 81 to be described later in FIG. 5A. As a result, the guitar amplifier 70 can output the musical sound based on the performance information input from the electric guitar 90 with effect processing added based on the setting instruction created on the PC 1.

Next, referring to FIGS. 5A and 5B, the electrical configuration of the PC 1 and the guitar amplifier 70 is described. FIG. 5A is a block diagram showing the electrical configuration of the PC 1 and the guitar amplifier 70. First, the electrical configuration of the PC 1 is described. The PC 1 includes a CPU 10, a hard disk drive (HDD) 11, and a RAM 12, which are connected to an input/output port 14 via a bus line 13. The input/output port 14 is further connected to the aforementioned mouse 2, keyboard 3, and LCD 4, as well as the communication device 15.

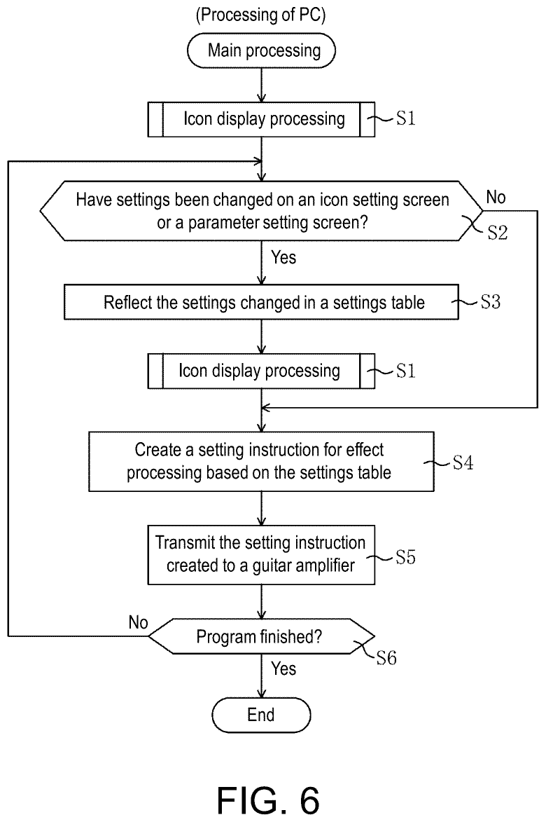

The CPU 10 is an arithmetic device that controls each of sections connected via the bus line 13. The HDD 11 is a rewritable non-volatile storage device that stores programs executed by the CPU 10 and fixed value data, etc., and stores a setting program 11a, the settings table 11b, and standard image data 11c. When the setting program 11a is executed in the CPU 10, the main processing shown in FIG. 6 is executed. Referring to FIG. 5B, the settings table 11b is described.

FIG. 5B is a schematic diagram showing the settings table 11b. The settings table 11b stores information related to the effectors assigned to the icons 42a to 42d. In the settings table 11b, No. 1 to 4 are assigned to the icons 42a to 42d respectively, and the type of effector (indicated as “Type” in the figure), the image file name of the icons 42a to 42d, and the setting information are stored in association with each other.

The type of effector stores the types of effectors assigned to the corresponding icons 42a to 42d. The image file name of the icons 42a to 42d stores the image file name specified in the icon setting screen 4b described above in FIGS. 2A and 2B. In the case where an image file name is not specified in the icon setting screen 4b and a standard image for the type of effector is used, “(DEFAULT)”is stored as the image file name.

The setting information stores various parameter setting information for the effectors assigned to the corresponding icons 42a to 42d. If the settings of various parameters are changed in the undepicted parameter setting screen mentioned above, such change is reflected in the setting information. Based on the type of effector and the setting information in the settings table 11b, a setting instruction for effect processing to be transmitted to the guitar amplifier 70 is created.

Specifically, since the order stored in the settings table 11b corresponds to the connection order of the icons 42 in the connection setting screen 4a, the connection order of effectors is created in the order stored in the settings table 11b. A setting instruction for effect processing is then created by combining the created connection order and the setting information set for each of the effectors. The created setting instruction is then transmitted to the guitar amplifier 70.

Referring to FIG. 5A again, the standard image data 11c stores standard images for the respective types of effectors mentioned above. In the case where “(DEFAULT)” is stored as the image file name in the settings table 11b mentioned above, the standard image corresponding to the type of effector is retrieved from the standard image data 11c and used as the image for the icons 42a to 42d.

The RAM 12 is a memory that can rewritably store various work data and flags, etc. when the CPU 10 executes programs such as the setting program 11a. The communication device 15 is a device that inputs and outputs information from a connected external device. In the embodiment, the guitar amplifier 70 is connected to the communication device 15, and the created setting instruction for effect processing is transmitted to the guitar amplifier 70 via the communication device 15.

Next, the electrical configuration of the guitar amplifier 70 is described. The guitar amplifier 70 includes the CPU 71, a flash ROM 72, a RAM 73, the communication device 74, the external input/output device 75, the sound source 76, and the DSP 77, each connected via a bus line 78. The Digital Analog Converter (DAC) 79 is connected to the DSP 77, the amplifier 80 is connected to the DAC 79, and the speaker 81 is connected to the amplifier 80.

The CPU 71 is an arithmetic device that controls each of sections connected via the bus line 78. The flash ROM 72 is a rewritable non-volatile memory, which mainly stores control programs, etc. for controlling each of the sections of the guitar amplifier 70. The RAM 73 is a memory that can rewritably store various work data and flags, etc. when the CPU 71 executes programs such as the control program.

The communication device 74 is a device that inputs and outputs information from a connected external device. In the embodiment, the communication device 15 of the PC 1 is connected to the communication device 74, and the setting instruction for effect processing created on the PC 1 is received by the guitar amplifier 70 via the communication device 74. In the guitar amplifier 70, the DSP 77 uses the setting instruction received from the PC 1 to add effect processing to the musical sound based on the performance information input from the electric guitar 90.

The external input/output device 75 is a device that inputs and outputs performance information from an external instrument. In the embodiment, the electric guitar 90 is connected to the external input/output device 75, and the performance information from the electric guitar 90 is input to the guitar amplifier 70 via the external input/output device 75.

The sound source 76 is a device that outputs waveform data corresponding to the performance information input from the CPU 71. The DSP 77 is an arithmetic device for performing arithmetic processing on the waveform data input from the sound source 76. The DAC 79 is a conversion device that converts the waveform data input from the DSP 77 into analog waveform data. The amplifier 80 is an amplification device that amplifies the analog waveform data output from the DAC 79 at a prescribed gain. The speaker 81 is an output device that emits (outputs) the analog waveform data amplified by the amplifier 80 as the musical sound.

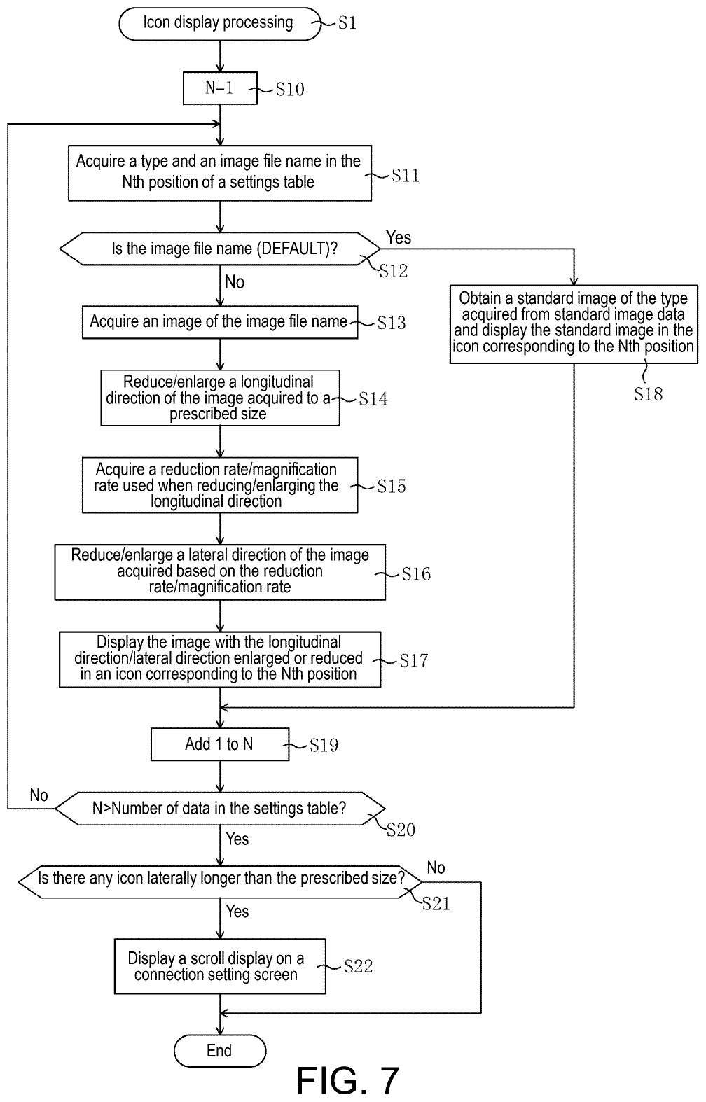

Next, referring to FIG. 6 and FIG. 7, the processing executed by the CPU 10 of the PC 1 is described. FIG. 6 is a flowchart of the main processing. The main processing is executed when the execution of the setting program 11a is instructed on the PC 1. The main processing first executes icon display processing (S1). Referring to FIG. 7, the icon display processing is described.

FIG. 7 is a flowchart of the icon display processing. The icon display processing first sets a counter variable N to 1. The counter variable N represents a numerical value indicating the icons 42a to 42d displayed in the connection setting screen 4a. Specifically, when the counter variable N is 1 (1st), the icon 42a is represented; when the counter variable N is 2 (2nd), the icon 42b is represented; when the counter variable N is 3 (3rd), the icon 42c is represented; and when the counter variable N is 4 (4th), the icon 42d is represented. Hereinafter, “N” in “Nth” indicates the value of the counter variable N.

After the processing of S10, the type of effector and the image file name in the Nth position of the settings table 11b are acquired (S11). After the processing of S11, it is confirmed whether the acquired image file name is “(DEFAULT)” (S12). In the processing of S12, if it is confirmed that the acquired image file name is not “(DEFAULT)” (S12: No), the image of the image file name (i.e., the specified image described above in FIGS. 2A and 2B) is acquired (S13).

After the processing of S13, the longitudinal direction of the image acquired in the processing of S13 is reduced or enlarged to the prescribed size (i.e., 300 pixels) (S14). After the processing of S14, the reduction rate or magnification rate used in the reduction or enlargement in the processing of S14 is acquired (S15).

After the processing of S15, the lateral direction of the image acquired in the processing of S13 is reduced or enlarged based on the reduction rate or magnification rate acquired in the processing of S14 (S16). After the processing of S17, the image with the longitudinal direction and the lateral direction reduced or enlarged in the processing of S14 and S16 is displayed as the image of the icon 42 corresponding to the Nth position (S17). As a result, the specified image designated in the icon setting screen 4b is displayed as the image of the icon 42 after being reduced or enlarged based on the prescribed size.

In the processing of S12, if it is confirmed that the acquired image file name is “(DEFAULT)” (S12: Yes), the standard image corresponding to the type of effector acquired in the processing of S11 is obtained from the standard image data 11c, and the acquired standard image is displayed as the image of the icon 42 corresponding to the Nth position (S18).

After the processing of S17 or S18, 1 is added to the counter variable N (S19), and it is confirmed whether the resulting counter variable N is greater than the number of data in the settings table 11b (i.e., “4”) (S20). In the processing of S20, if it is confirmed that the counter variable N is not greater than the number of data in the settings table 11b (S20: No), the processing of S11 and subsequent steps is repeated.

On the other hand, in the processing of S20, if it is confirmed that the counter variable N is greater than the number of data in the settings table 11b (S20: Yes), it is confirmed whether there is any icon 42 of which image length in the lateral direction is longer than the prescribed size (200 pixels) in the lateral direction (S21). In the processing of S21, if it is confirmed that there is an icon 42 of which image length in the lateral direction is longer than the prescribed size in the lateral direction (S21: Yes), the scroll display 45 is displayed on the connection setting screen 4a (S22).

On the other hand, in the processing of S21, if it is confirmed that there is no icon 42 of which image length in the lateral direction is longer than the prescribed size in the lateral direction (S21: No), or after the processing of S22, the icon display processing is terminated.

Referring to FIG. 6 again, after the icon processing of S1, it is confirmed whether settings have been changed on the icon setting screen 4b or the undepicted parameter setting screen (S2). In the processing of S2, if it is confirmed that settings have been changed on the icon setting screen 4b or the undepicted parameter setting screen (S2: Yes), the changed settings are reflected in the settings table 11b (S3).

Specifically, in the case where a specified image is designated on the icon setting screen 4b, the image file name of the specified image is stored in the corresponding image file name in the settings table 11b, and in the case where the settings of various parameters are changed on the parameter setting screen, the changed parameters are reflected in the corresponding setting information in the settings table 11b.

After the processing of S3, the icon display processing (S1) described above in FIG. 7 is executed. This updates the display of the icon 42 on the connection setting screen 4a due to the setting change made on the icon setting screen 4b. In the processing of S2, if it is not confirmed that settings have been changed on the icon setting screen 4b or the undepicted parameter setting screen (S2: No), the processing of S3 and the subsequent icon display processing of S1 are skipped.

After the processing of S2 and S3, a setting instruction for effect processing is created based on the settings table 11b (S4), and the created setting instruction is transmitted to the guitar amplifier 70 via the communication device 15 (S5). In the guitar amplifier 70, effect processing is added to the musical sound based on the performance information input from the electric guitar 90, using the setting instruction received from the PC 1.

After the processing of S5, it is confirmed whether an instruction to terminate the setting program 11a has been input by the user H via the mouse 2 or the keyboard 3 (S6). In the processing of S6, if it is not confirmed that an instruction to terminate the setting program 11a has been input (S6: No), the processing of S2 and subsequent steps is repeated. Also, in the processing of S6, if it is confirmed that an instruction to terminate the setting program 11a has been input (S6: Yes), the main processing is terminated.

Although the disclosure has been described based on the above embodiments, it can be easily inferred that various improvements and modifications may be made.

In the above embodiment, the specified image designated by the user H is reduced or enlarged in the longitudinal direction to the prescribed size, and the lateral direction of the specified image is reduced or enlarged using the reduction rate or magnification rate applied when reducing or enlarging in the longitudinal direction. However, the disclosure is not limited thereto. For example, the lateral direction of the specified image may be reduced or enlarged to the prescribed size (e.g., 200 pixels), and the longitudinal direction of the specified image may be reduced or enlarged using the reduction rate or magnification rate applied when reducing or enlarging in the lateral direction.

Additionally, an image reduced or enlarged in both the longitudinal direction and the lateral direction of the specified image to the respective prescribed sizes thereof (for example, longitudinal direction: 300 pixels, lateral direction: 200 pixels) may be displayed as the icon 42. Furthermore, an image with merely the longitudinal direction of the specified image reduced or enlarged to the prescribed size, while maintaining the length of the lateral direction of the specified image, may be displayed as the icon 42. Alternatively, an image with the lateral direction of the specified image reduced or enlarged to the prescribed size, while maintaining the length of the longitudinal direction of the specified image, may be displayed as the icon 42.

Alternatively, the longitudinal direction or the lateral direction of the specified image is not limited to being reduced or enlarged to the prescribed size. The longitudinal direction or the lateral direction of the specified image may be reduced or enlarged to a length that is shorter than the prescribed size by a specified number of pixels (for example, 10 pixels), or the longitudinal direction or the lateral direction of the specified image may be reduced or enlarged to a length that is longer than the prescribed size by a specified number of pixels (for example, 5 pixels). Furthermore, the specified image may be displayed as the icon 42 without any reduction or enlargement.

In the above embodiment, various parameters of the effector are set in an undepicted parameter setting screen. However, the disclosure is not limited thereto. For example, in the case where the user H specifies an image to change the image of the icon 42, the setting information of the effector included in the image may be reflected in the settings of the effector corresponding to the icon 42 for which the image is being changed.

In this case, the image specified by the user H and the setting information corresponding to the image may be stored in association with each other in the HDD 11 or the like. The setting information corresponding to the specified image may be obtained and applied to the settings of the effector for the icon 42 for which the image is being changed. As a result, not only the image of the icon 42 but also the settings of the effector corresponding to the icon 42 become consistent with the specified image, thereby facilitating the setting of the effector.

In the above embodiment, the configuration is such that the settings of the effect processing created on the PC 1 are transmitted to the guitar amplifier 70. However, the disclosure is not limited thereto. The settings of the effect processing created on the PC 1 may be transmitted to other electronic instruments that add effect processing to musical sounds. Furthermore, while the electric guitar 90 is connected to the guitar amplifier 70, the disclosure is not limited thereto, and other instruments such as an electric bass may be connected to the guitar amplifier 70.

In the above embodiment, the standard image data 11c stored pre-created standard images for respective effectors. However, the disclosure is not limited thereto. For example, the standard images for respective effectors in the standard image data 11c may be rewritten to images specified by the user H. For instance, by rewriting the standard image for “CHORUS” in the standard image data 11c with “MyChorus. jpg” shown in FIGS. 2A and 2B and FIGS. 3A and 3B, all the images of the icons 42 that are set to the standard image for “CHORUS” are to be replaced with “MyChorus. jpg”. This allows the images displayed on the icons 42 to be flexibly customized according to the user H's preferences.

In the above embodiment, the PC 1 is exemplified as the computer executing the setting program 11a. However, the disclosure is not limited thereto. The setting program 11a may be executed on information processing devices such as smartphones, tablet terminals, or electronic instruments, or other electronic devices. Additionally, the setting program 11a may be stored in the guitar amplifier 70 and executed on the guitar amplifier 70, or the setting program 11a may be executed on other electronic instruments capable of applying effect processing, such as synthesizers, electronic percussion instruments, or electronic wind instruments. In this case, the guitar amplifier 70 or the like may be provided with a display device such as an LCD and an input device such as setting buttons. Alternatively, the disclosure may be applied to a dedicated device (setting device) that stores the setting program 11a in a ROM or the like and merely executes the setting program 11a.

What is claimed is:

1. A setting system comprising an electronic instrument and a setting device,
the electronic instrument comprising a first processor for
inputting performance information,
adding effect processing to a musical sound based on the performance information input,
outputting the musical sound with the effect processing added,
receiving a setting instruction from the setting device in which an order of the effect processing or parameters of the effect processing are set, and
updating the order of the effect processing or the parameters of the effect processing to be added to the musical sound based on the setting instruction received, and
the setting device comprising a second processor for
displaying an effector icon which shows a standard image imitating an effector that performs the effect processing,
acquiring an effector icon specified by a user from among the effector icons displayed,
acquiring a specified image specified by the user,
displaying the specified image acquired instead of the standard image in the effector icon acquired,
acquiring a connection order of the effector icons displayed set by the user,
creating a setting instruction in which an order of the effect processing is set based on the connection order of the effector icons acquired, and
transmitting the setting instruction set to the electronic instrument.

2. The setting system according to claim 1, wherein the second processor further
reduces or enlarges the specified image acquired based on a prescribed size of an image of the effector icon, and
displays the specified image that has been reduced or enlarged instead of the standard image in the effector icon acquired.

3. The setting system according to claim 2, wherein the second processor displays the effector icon in a lateral direction,
reduces or enlarges a longitudinal direction of the specified image acquired based on the prescribed size in a longitudinal direction of the image of the effector icon, and
displays the specified image with the longitudinal direction thereof reduced or enlarged instead of the standard image in the effector icon acquired.

4. The setting system according to claim 3, wherein the second processor reduces or enlarges the longitudinal direction of the specified image acquired based on the prescribed size in the longitudinal direction of the image of the effector icon, further reduces or enlarges a lateral direction of the specified image using a reduction rate or magnification rate when reducing or enlarging the longitudinal direction, and
displays the specified image with the longitudinal direction and the lateral direction thereof respectively reduced or enlarged instead of the standard image in the effector icon acquired.

5. The setting system according to claim 2, wherein
when the effector icon becomes elongated laterally as a result of displaying the specified image in the effector icon acquired and all of a plurality of the effector icons are unable to be displayed in a display area for displaying the effector icons, the second processor further displays a scroll display for switching the effector icons to be displayed in the display area.

6. The setting system according to claim 1, wherein the second processor is capable of displaying a plurality of effector icons that imitate effectors performing the same type of the effect processing,
acquires an effector icon specified by the user from among the plurality of effector icons displayed that imitate effectors performing the same type of the effect processing, and
displays the specified image acquired instead of the standard image in the effector icon acquired.

7. A setting method for causing a computer comprising a display section and connected to an electronic instrument to create a setting instruction and transmit the setting instruction to the electronic instrument which
inputs performance information,
adds effect processing to a musical sound based on the performance information input,
outputs the musical sound with the effect processing added,
receives a setting instruction in which an order of the effect processing or parameters of the effect processing are set, and
updates the order of the effect processing or the parameters of the effect processing to be added to the musical sound based on the setting instruction received, and causing the computer to execute:
a display step of displaying an effector icon which shows a standard image imitating an effector that performs the effect processing on the display section;
a specified icon acquisition step of acquiring an effector icon specified by a user from among the effector icons displayed on the display section;
a specified image acquisition step of acquiring a specified image specified by the user;
an image change step of displaying the specified image acquired in the specified image acquisition step instead of the standard image in the effector icon acquired in the specified icon acquisition step;
a connection order acquisition step of acquiring a connection order of the effector icons displayed on the display section, as set by the user;
a setting instruction creation step of creating a setting instruction in which an order of the effect processing is set based on the connection order of the effector icons acquired in the connection order acquisition step; and
a transmission step of transmitting the setting instruction set in the setting instruction creation step to the electronic instrument.

8. A setting device connected to an electronic instrument that
inputs performance information,
adds effect processing to a musical sound based on the performance information input,
outputs the musical sound with the effect processing added,
receives a setting instruction in which an order of the effect processing or parameters of the effect processing are set, and
updates the order of the effect processing or the parameters of the effect processing to be added to the musical sound based on the setting instruction received, and the setting device comprising a processor for
displaying an effector icon which shows a standard image imitating an effector that performs the effect processing,
acquiring an effector icon specified by a user from among the effector icons displayed,
acquiring a specified image specified by the user,
displaying the specified image acquired instead of the standard image in the effector icon acquired,
acquiring a connection order of the effector icons displayed set by the user,
creating a setting instruction in which an order of the effect processing is set based on the connection order of the effector icons acquired, and
transmitting the setting instruction set to the electronic instrument.

9. The setting system according to claim 3, wherein
when the effector icon becomes elongated laterally as a result of displaying the specified image in the effector icon acquired and all of a plurality of the effector icons are unable to be displayed in a display area for displaying the effector icons, the second processor further displays a scroll display for switching the effector icons to be displayed in the display area.

10. The setting system according to claim 4, wherein
when the effector icon becomes elongated laterally as a result of displaying the specified image in the effector icon acquired and all of a plurality of the effector icons are unable to be displayed in a display area for displaying the effector icons, the second processor further displays a scroll display for switching the effector icons to be displayed in the display area.

11. The setting system according to claim 2, wherein the second processor is capable of displaying a plurality of effector icons that imitate effectors performing the same type of the effect processing,
acquires an effector icon specified by the user from among the plurality of effector icons displayed that imitate effectors performing the same type of the effect processing, and
displays the specified image acquired instead of the standard image in the effector icon acquired.

12. The setting system according to claim 3, wherein the second processor is capable of displaying a plurality of effector icons that imitate effectors performing the same type of the effect processing,
acquires an effector icon specified by the user from among the plurality of effector icons displayed that imitate effectors performing the same type of the effect processing, and
displays the specified image acquired instead of the standard image in the effector icon acquired.

13. The setting system according to claim 4, wherein the second processor is capable of displaying a plurality of effector icons that imitate effectors performing the same type of the effect processing,
acquires an effector icon specified by the user from among the plurality of effector icons displayed that imitate effectors performing the same type of the effect processing, and
displays the specified image acquired instead of the standard image in the effector icon acquired.

14. The setting method according to claim 7, further causing the computer to execute:
an enlargement step of reducing or enlarging the specified image acquired based on a prescribed size of an image of the effector icon; and
a display step of displaying the specified image that has been reduced or enlarged instead of the standard image in the effector icon acquired.

15. The setting method according to claim 14, causing the computer to execute:
a display step of displaying the effector icon in a lateral direction;
a step of reducing or enlarging a longitudinal direction of the specified image acquired based on the prescribed size in a longitudinal direction of the image of the effector icon; and
a display step of displaying the specified image with the longitudinal direction thereof reduced or enlarged instead of the standard image in the effector icon acquired.

16. The setting device according to claim 8, wherein
the processor further
reduces or enlarges the specified image acquired based on a prescribed size of an image of the effector icon, and
displays the specified image that has been reduced or enlarged instead of the standard image in the effector icon acquired.

17. The setting device according to claim 16, wherein
the processor displays the effector icon in a lateral direction,
reduces or enlarges a longitudinal direction of the specified image acquired based on the prescribed size in a longitudinal direction of the image of the effector icon, and
displays the specified image with the longitudinal direction thereof reduced or enlarged instead of the standard image in the effector icon acquired.

18. The setting device according to claim 17, wherein the processor reduces or enlarges the longitudinal direction of the specified image acquired based on the prescribed size in the longitudinal direction of the image of the effector icon, further reduces or enlarges a lateral direction of the specified image using a reduction rate or magnification rate when reducing or enlarging the longitudinal direction, and
displays the specified image with the longitudinal direction and the lateral direction thereof respectively reduced or enlarged instead of the standard image in the effector icon acquired.

19. The setting device according to claim 16, wherein
when the effector icon becomes elongated laterally as a result of displaying the specified image in the effector icon acquired and all of a plurality of the effector icons are unable to be displayed in a display area for displaying the effector icons, the processor further displays a scroll display for switching the effector icons to be displayed in the display area.

20. The setting device according to claim 8, wherein the processor is capable of displaying a plurality of effector icons that imitate effectors performing the same type of the effect processing,
acquires an effector icon specified by the user from among the plurality of effector icons displayed that imitate effectors performing the same type of the effect processing, and
displays the specified image acquired instead of the standard image in the effector icon acquired.
